(19) United States
(12) Patent Application Publication
(10) Pub. No.: US 2012/0089703 A1
(43) Pub. Date: Apr. 12, 2012

(54) INFORMATION PROCESSING APPARATUS AND METHOD OF CONTROLLING THE SAME, AND STORAGE MEDIUM

(75) Inventor: Satoki Watariuchi, Kawasaki-shi (JP)

(73) Assignee: CANON KABUSHIKI KAISHA, Tokyo (JP)

(21) Appl. No.: 13/219,305

(22) Filed: Aug. 26, 2011

(30) Foreign Application Priority Data
Oct. 6, 2010 (JP) 2010-226825

(51) Int. Cl. G06F 15/16

(52) U.S. Cl. 709/218

(57) ABSTRACT

An information processing apparatus having a Web browser, which is capable of communicating with a Web server, and displays an operation screen based on screen information supplied by the Web server, and a control method of the information processing apparatus are provided. The information processing apparatus displays an operation screen based on screen information supplied by the Web server, transmits a request to the Web server based on a user operation through the operation screen displayed by the Web browser, and in a case where an event occurs in the information processing apparatus, specifies a constituent element of the operation screen corresponding to the occurred event and transmits a request, to the Web server, which is similar to a case where a user selects the constituent element.

### BACKGROUND OF THE INVENTION

1. Field of the Invention

The present invention relates to an information processing apparatus having a Web browser, which is capable of communicating with a Web server, displays an operation screen based on image information supplied by the Web server, a method of controlling the information processing apparatus, and a storage medium.

2. Description of the Related Art

It is well known that an information processing apparatus, such as a PC, performs communication with a Web server in a network, and based on screen information provided by the Web server, displays an operation screen using a Web browser installed in the information processing apparatus.

In this case, first, a Web browser in an information processing apparatus requests screen information to a Web server. In response to the request, a Web application in the Web server sends HTML (Hyper Text Markup Language) data (response) to the information processing apparatus for having the Web browser display an operation screen. The Web browser in the information processing apparatus analyzes the received HTML data, and displays an operation screen according to the description of the HTML data. Furthermore, when a user inputs an instruction through the operation screen which is displayed by the Web browser, the Web browser notifies the Web server of the input instruction. The Web application in the Web server, which has received the notification, executes processing in accordance with the input instruction.

Meanwhile, recently, some multi-function peripherals (MFP) comprising a scanner or printer include the above-described Web browser. In such an MFP, based on screen information which is provided by the Web server in accordance with the aforementioned procedure, an operation screen can be displayed by the Web browser of the MFP and various instructions from a user can be received.

Furthermore, a technique disclosed by Japanese Patent Laid-Open No. 2006-127503 (D1) has also been proposed. According to D1, a Web server provides screen information for displaying an operation screen, to which an instruction for using each function of an MFP is input. Through the operation screen displayed by a Web browser, an MFP user inputs an instruction to the MFP. The input instruction is notified to the Web server by the Web browser of the MFP. The Web server, which has received the notification, requests the MFP to execute various processing in accordance with the content of the instruction input by the user. The MFP, which has received the request, executes the requested processing. Accordingly, it is no longer necessary for the MFP to store all menu data for operating the MFP. Also, modification of the menu data can readily be performed in the Web server.

Assuming that menu data is stored in the Web server in the above-described manner, in a case where menu data is managed for each user, the user must be authenticated and must log into a Web application in order to display the menu data. In this case, if authentication is to be performed by the MFP, double authentication, that is, authentication by the MFP and authentication by the Web application, is required. In order to ease user's burden in such double authentication, a technique disclosed by the Japanese Patent Laid-Open No. 2008-83809 (D2) has been proposed.

According to D2, authentication by an MFP is performed in conjunction with authentication by a Web application. Accordingly, when a user performs login or logout of the MFP, the user can automatically perform login or logout of the Web application. However, in the method proposed by D2, a table is necessary for tying MFP authentication data to Web application authentication data, and this causes a problem of cumbersome management.

In view of the aforementioned problem, it is possible to suggest performing authentication not by an MFP, but by a Web application only. In an initial screen for the MFP which is displayed by the Web browser, an authentication screen for the Web application is displayed. By virtue of this method, authentication by the Web application is combined with authentication by the MFP, and as a result, authentication data can be managed collectively by the Web application. However in this case, the following problem may arise.

When authentication is performed not by an MFP, but by a Web application only, a user must always log out of the Web application when he/she ends using the MFP. If a user does not log out of the Web application when he/she ends using the MFP, the next user can use the MFP despite the state that the previous user is still logged in.

The necessity of logout after use of an MFP is also the same in the case of performing authentication by the MFP. However, an MFP has a mechanism called auto-clear, which automatically resets the MFP state if no operation is performed for a predetermined period of time. If the MFP is not operated for a predetermined period of time, an auto-clear event occurs and automatic logout is performed. By virtue of the auto-clear mechanism, a certain level of security is maintained.

On the contrary, in a case of performing authentication by a Web application only, even if an auto-clear event occurs, the MFP remains logged in the Web application. Therefore, the next user can use the MFP despite the state that the previous user is still logged in. This causes a serious problem in terms of security.

### SUMMARY OF THE INVENTION

An aspect of the present invention is to eliminate the above-mentioned problems with the conventional technology.

The present invention is characterized in that, based on an event occurred in an information processing apparatus, it is possible to cause execution of processing similar to the case where a user operates the constituent element on an operation screen. Accordingly, for instance, at the time of an event which occurs if no user operation is performed for a predetermined period of time, it is possible to provide a mechanism for automatically logging out of a Web application.

According to an aspect of the present invention there is provided an information processing apparatus having a Web browser, which is capable of communicating with a Web server, and displays an operation screen based on screen information supplied by the Web server, comprising: a transmission unit configured to transmit a request to the Web server based on a user operation through the operation screen displayed by the Web browser; and a control unit configured to, in a case where an event occurs in the information processing apparatus, specify a constituent element of the operation screen, which is corresponding to the occurred event, and transmit a request, to the Web server, which is similar to a case where a user selects the constituent element.

According to an aspect of the present invention there is provided a control method of controlling an information processing apparatus having a Web browser, which is capable of communicating with a Web server, and displays an operation screen based on screen information supplied by the Web server, the method comprising: transmitting a request to the Web server based on a user operation through the operation screen displayed by the Web browser; and controlling, in a case where an event occurs in the information processing apparatus, to specify a constituent element of the operation screen, which is corresponding to the occurred event, and transmit a request, to the Web server, which is similar to a case where a user selects the constituent element.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is an explanatory diagram showing an overall configuration of an information processing system according to an embodiment of the present invention;

FIG. 2 is a block diagram describing a configuration of an MFP according to the embodiment;

FIG. 3 is a block diagram describing a configuration of a Web server according to the embodiment;

FIG. 4 is a diagram describing a software configuration of an information processing system according to the embodiment;

FIG. 5 is a flowchart for describing processing executed by a Web browser in an MFP;

FIG. 6 is a flowchart for describing processing executed by a Web application in a Web server;

FIG. 7 is a flowchart for describing processing executed by a service provider in an MFP;

FIG. 8 is a flowchart for describing event processing executed by a Web browser in an MFP;

FIG. 9 depicts an explanatory view showing a data structure of an event table included in an MFP; and

FIGS. 10A to 10C depict view illustrating examples of specific description of a source (HTML data) of an operation screen displayed by a Web browser according to the embodiment.

### DESCRIPTION OF THE EMBODIMENTS

Embodiments of the present invention will now be described hereinafter in detail, with reference to the accompanying drawings. It is to be understood that the following embodiment is not intended to limit the claims of the present invention, and that not all of the combinations of the aspects that are described according to the following embodiment are necessarily required with respect to the means to solve the problems according to the present invention.

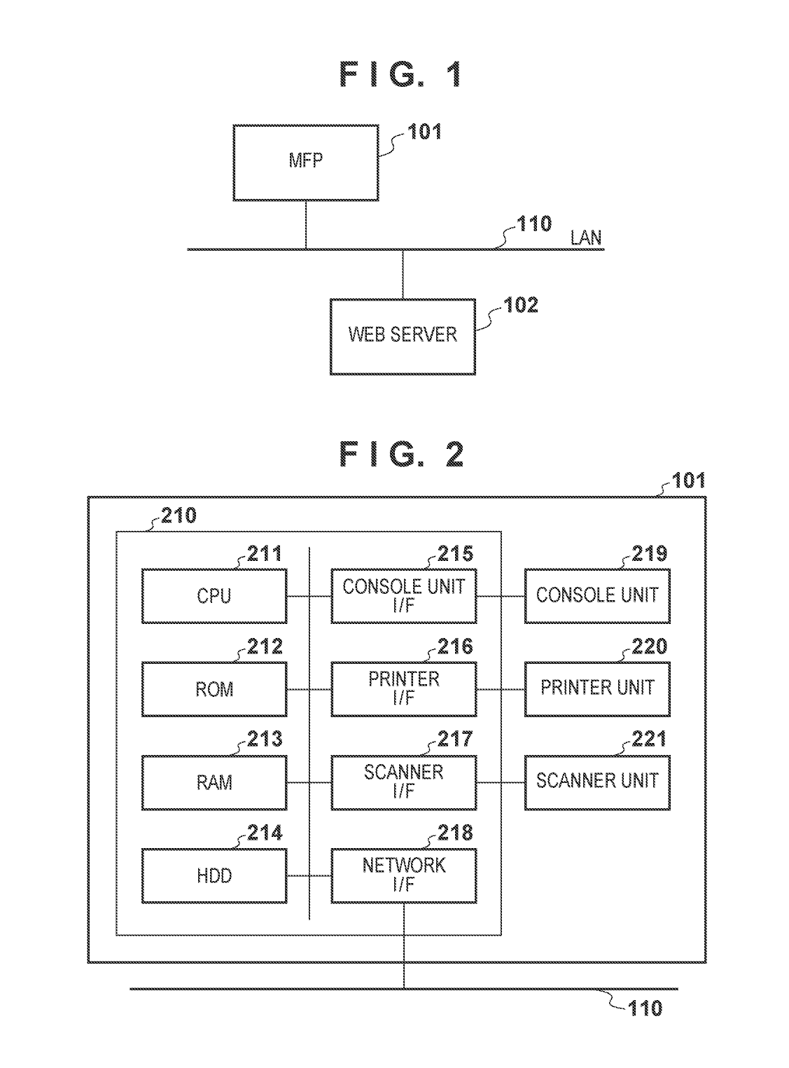

FIG. 1 is an explanatory diagram showing an overall configuration of an information processing system according to an embodiment of the present invention.

An MFP 101 and a Web server 102 are connected in a way that they are mutually communicatable through a LAN 110. The MFP 101 is a multi-function peripheral having functions for printing, scanning, facsimile transmission/reception, storage and so on. The MFP 101 requests screen information of an operation screen to the Web server 102 by designating a URL using a Web browser, which is incorporated in the MFP 101. In response to the request, the Web server 102 generates HTML data by a Web application for having the Web browser display the operation screen, and transmits it to the MFP 101. The MFP 101 analyzes the received HTML data using the Web browser, and based on the analysis, displays a screen according to the description of the HTML data on a console unit (219 in FIG. 2). When the MFP 101 receives information input from a user on the screen displayed by the Web browser, the MFP 101 notifies the Web server 102 of the input information. The Web server 102, which has received the notification, executes processing in accordance with the input information, and transmits HTML data (screen information) again to the MFP 101. In this manner, a screen according to the input information is displayed on the console unit.

FIG. 2 is a block diagram describing a configuration of the MFP 101 according to the embodiment.

A control unit 210 including a CPU 211 controls the overall operation of the MFP 101. The CPU 211 reads programs and OS installed in a HDD 214 using a boot program stored in a ROM 212, and develops them in a RAM 213. By executing the programs developed in the RAM 213 by the CPU 211, various control processing, such as document reading control, transmission control or the like, as well as processing which will be described later are executed. Further, the RAM 213 is used as a main memory of the CPU 211, or as a temporary storage area, such as a work area. The HDD 214 stores image data, various programs, and various information tables.

A console unit interface (I/F) 215 connects a console unit 219 with the control unit 210. The console unit 219 comprises a liquid crystal display unit having a touch panel function, a keyboard, and the like. The MFP 101 has a Web browser function which will be described later. The Web browser in the MFP 101 analyzes a HTML file received from the Web server 102, and displays an operation screen according to description of the HTML file on a display unit of the console unit 219.

A printer I/F 216 connects a printer unit 220 with the control unit 210. Image data to be printed by the printer unit 220 is transferred from the control unit 210 to the printer unit 220 through the printer I/F 216, and printed on a printing medium (sheet) by the printer unit 220. A scanner I/F 217 connects a scanner unit 221 with the control unit 210. The scanner unit 221 reads an image on a document for image data generation, and supplies the image data to the control unit 210 through the scanner I/F 217. A network I/F 218 connects the MFP 101 with the LAN 110. The network I/F 218 transmits image data and information to an external apparatus (e.g., Web server 102) through the LAN 110, or receives various information from an external apparatus connected to the LAN 110.

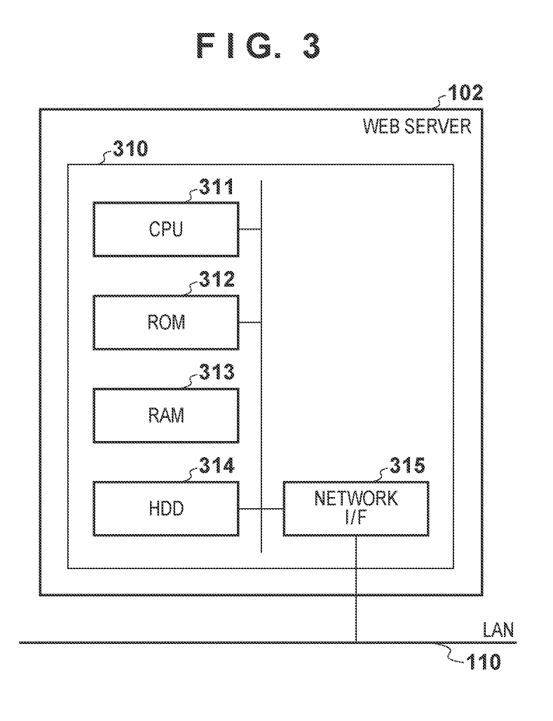

FIG. 3 is a block diagram describing a configuration of the Web server 102 according to the present embodiment.

A control unit 310 including a CPU 311 controls the overall operation of the Web server 102. The CPU 311 reads various programs installed in a HDD 314 using a boot program stored in a ROM 312, develops them in a RAM 313, and executes various control in accordance with the programs developed in the RAM 313. The RAM 313 is used as a main memory of the CPU 311, or as a temporary storage area, such as a work area. The HDD 314 stores image data, various programs, and various information tables. A network I/F 315 connects the Web server 102 with the LAN 110. The network I/F 315 performs transmission or reception of various information with other apparatuses connected to the LAN 110.

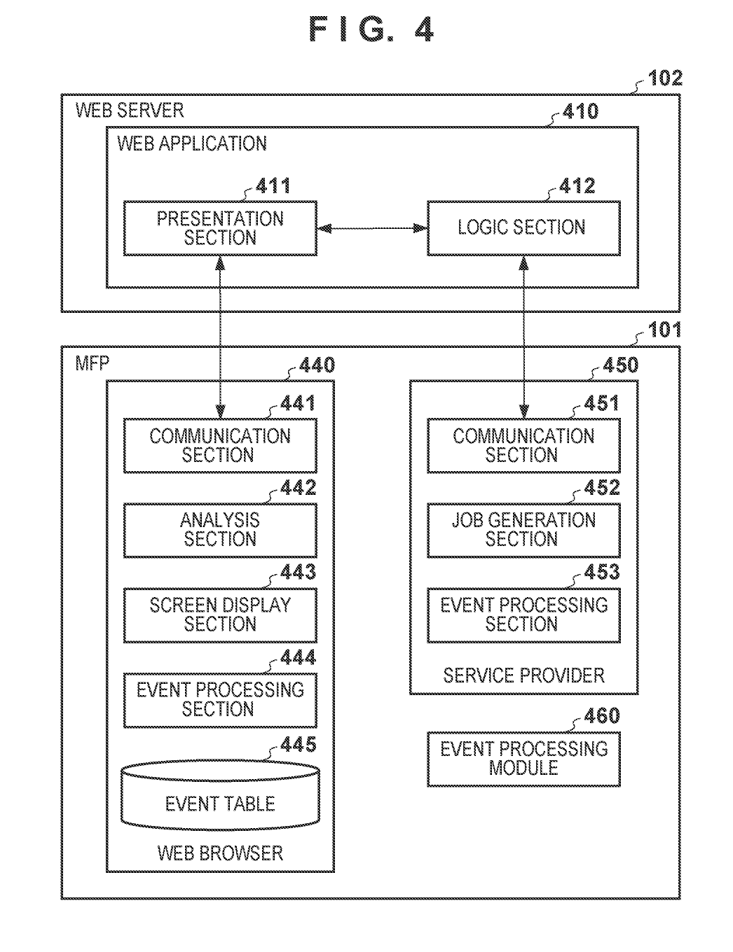

FIG. 4 is a diagram describing a software configuration of the information processing system according to the present embodiment. Each of the functional sections (units) shown in FIG. 4 is realized by executing a control program stored in the MFP 101 or Web server 102 by the CPU 211 or CPU 311.

The MFP 101 comprises a Web browser 440, a service provider 450, and an event processing module 460. The Web browser 440 comprises a communication section 441, an analysis section 442, a screen display section 443, an event processing section 444, and an event table 445. The communication section 441 performs communication with a presentation section 411 of the Web application 410 in accordance with a HTTP protocol. More specifically, the communication section 441 requests the Web application 410 in the Web server 102 of information regarding an operation screen to be displayed by the Web browser 440. Furthermore, the communication section 441 transmits information, which is input through the operation screen displayed by the Web browser 440, as a request to the Web application 410. Further, the communication section 441 receives a response (processing result) transmitted by the Web application 410.

The analysis section 442 analyzes the response received from the Web application 410 of the Web server 102. The response includes HTML data. The HTML data includes a description, which is indicative of the content of an operation screen to be displayed by the Web browser 440. Based on the analysis result of the HTML data, the screen display section 443 displays an operation screen on the console unit 219. The event processing section 444 receives an event occurrence notification from the event processing module 460, and performs processing corresponding to the occurred event with reference to the event table 445. Note that an event herein includes all types of events that occur in the MFP 101, such as an auto-clear event which occurs if no operation is performed on the MFP 101 for a predetermined period of time, a key input event which occurs when a hard key is depressed, or the like.

The event table 445 is provided for managing keywords corresponding to various events. The keywords are associated with screen information, such as a HTML file, which is received by the Web browser 440 from the Web server 102. Note that the event table 445 is stored in a storage unit of the MFP 101, for instance, the HDD 214.

The service provider 450 comprises a communication section 451, a job generation section 452, and an event processing section 453. The communication section 451 receives a processing request from a logic section 412 of the Web application 410. The job generation section 452 receives the processing request, which has been received by the communication section 451, generates a job for executing the requested processing, and executes the job. The event processing section 453 receives an event occurrence notification from the event processing module 460, and performs necessary processing in accordance with the received event. The event processing module 460 is provided for processing an event that has occurred in the MFP 101. Also, the event processing module 460 notifies the Web browser 440 or service provider 450 of an event occurred in the MFP 101 as needed.

The Web server 102 comprises the Web application 410. The Web application 410 is realized by executing a program by the CPU 311 in the Web server 102. The Web application 410 receives information which is transmitted as a request from the Web browser 440, and executes processing based on the received information. The processing result is transmitted as a response from the Web application 410 to the Web browser 440. The Web application 410 includes the presentation section 411 and the logic section 412. The presentation section 411 performs communication with the communication section 441, and receives a request transmitted by the MFP 101. The presentation section 411 notifies the logic section 412 of the received request, and waits for a response from the logic section 412. The presentation section 411, which has received a response from the logic section 412, transmits HTML data, which is corresponding to the operation screen to be displayed by the Web browser 440 of the MFP 101, in accordance with the response content. Further, information input through the operation screen displayed by the Web browser 440 of the MFP 101 is transmitted from the communication section 441 as a request.

The logic section 412 executes various processing in accordance with a request notified by the presentation section 411, and requests the MFP 101 to execute processing. More specifically, execution of print processing by the printer unit 220 of the MFP 101, execution of document reading processing by the scanner unit 221, or execution of transmission processing via the network I/F 218 are requested. When processing execution is requested to the MFP 101, the logic section 412 communicates with the communication section 451 of the service provider 450 in the MFP 101. The logic section 412 receives, from the MFP 101, a processing result executed by the MFP 101.

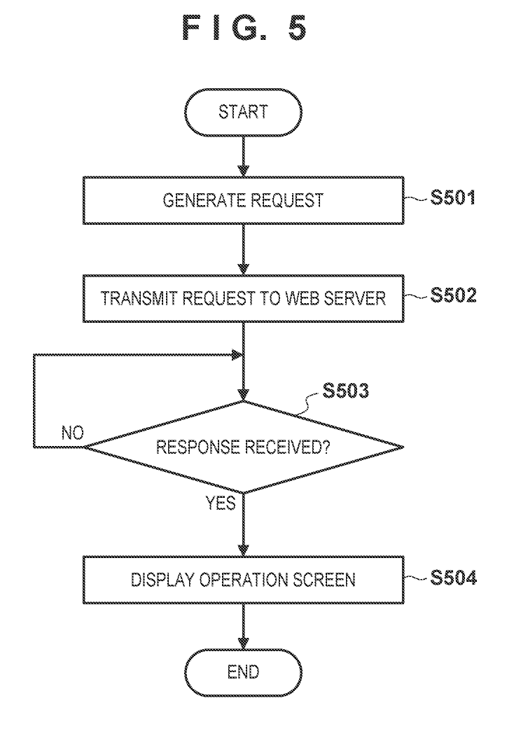

Next, described with reference to the flowchart in FIG. 5 is request processing of an operation screen by the Web browser 440.

FIG. 5 is a flowchart for describing processing executed by the Web browser 440 in the MFP 101. This processing is executed by the Web browser 440, when the CPU 211 of the MFP 101 executes a program developed in the RAM 213.

In step S501, the Web browser 440 generates a request for requesting the Web server 102 of the screen information of an operation screen which is to be displayed on the display unit of the console unit 219. This request may be of a URL which is set in advance as a homepage or the like of the Web browser 440, a URL input by a user in the URL input field of the Web browser 440, or a URL of a link selected by a user on a screen displayed by the Web browser 440. Next, in step S502, the Web browser 440 transmits the request, which is generated in step S501, to the Web server 102.

In step S503, the Web browser 440 determines, in response to the request that has been transmitted in step S502, whether or not screen information of an operation screen has been transmitted from the Web server 102. In reality, a HTML file or the like is transmitted from the Web server 102 as the screen information for displaying an operation screen by the Web browser 440. When screen information of an operation screen is received in step S503, the processing proceeds to step S504; whereas if screen information is not received, the processing stands by until screen information is received in step S503. In step S504, the Web browser 440 displays an operation screen on the display unit of the console unit 219 in accordance with the description of the received HTML file.

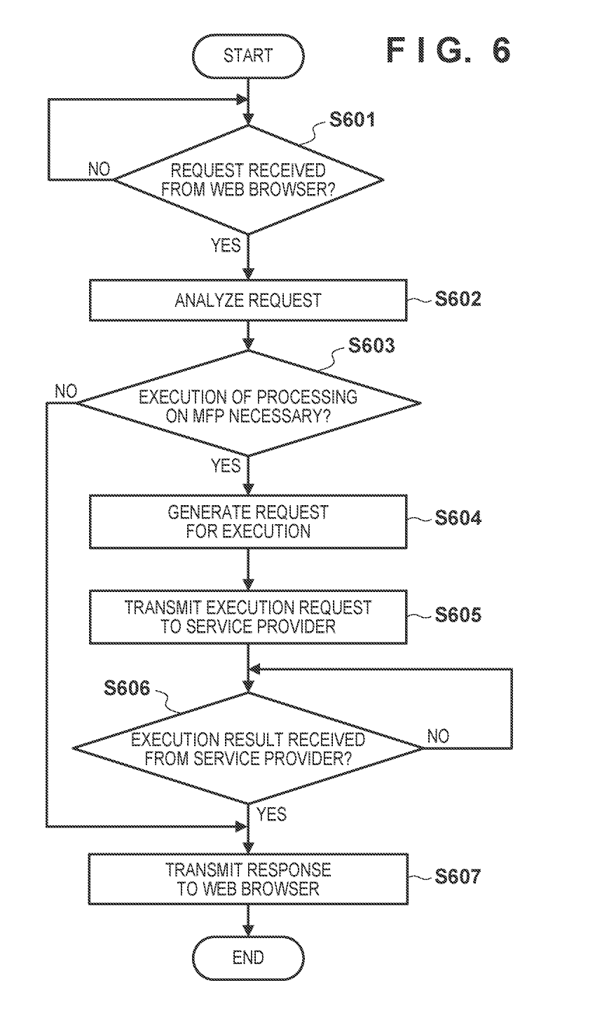

Next, response processing performed by the Web server 102 in response to a request from the Web browser 440 is described with reference to FIG. 6.

FIG. 6 is a flowchart for describing processing executed by the Web application 410 in the Web server 102. This processing is realized by executing, by the CPU 311 of the Web server 102, a program developed in the RAM 313.

In step S601, the Web application 410 determines whether or not a request of screen information of an operation screen is received from the Web browser 440. If a request is received, the processing proceeds to step S602; whereas if a request is not received, the processing stands by until a request is received in step S601. In step S602, the Web application 410 analyzes the request received in step S601. Next, in step S603, the Web application 410 determines whether or not an execution of processing on the MFP 101 is necessary. If it is determined that the execution on the MFP 101 is necessary, the processing proceeds to step S604; whereas if it is determined that the execution is not necessary, the processing proceeds to step S607.

In step S604, the Web application 410 generates a request for the execution of processing on the MFP 101. In step S605, the request for the execution is transmitted to the service provider 450 of the MFP 101. Next in step S606, the Web application 410 determines whether or not a processing result based on the execution request is received from the service provider 450 of the MFP 101. If a processing result is received, the processing proceeds to step S607; whereas if not, the processing stands by in step S606 until a processing execution result is received. In step S607, the Web application 410 transmits a response with regard to the processing result to the Web browser 440. In reality, the response includes a HTML file or the like for displaying an operation screen by the Web browser 440 based on the request from the Web browser 440.

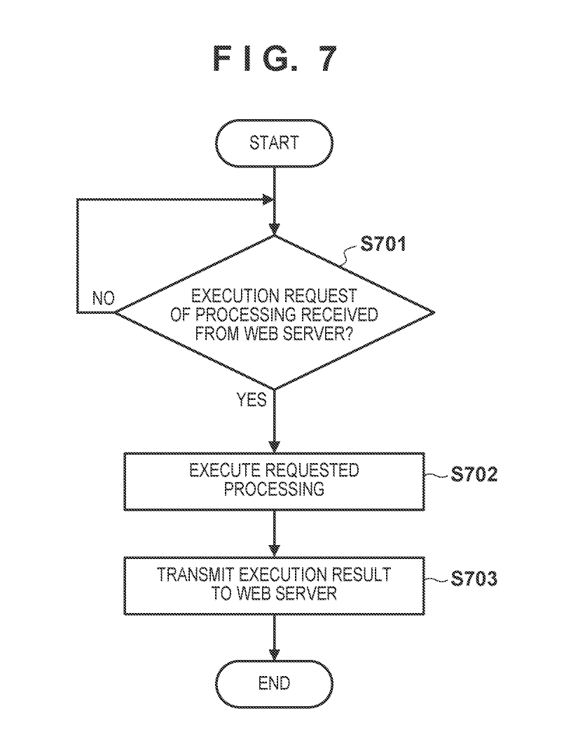

Next, with reference to FIG. 7, processing of the service provider 450 in the MFP 101 is described.

FIG. 7 is a flowchart for describing processing executed by the service provider 450 in the MFP 101 according to the embodiment. This processing is executed by the service provider 450, and is realized when the CPU 211 of the MFP 101 executes a program developed in the RAM 213.

In step S701, the service provider 450 determines whether or not an execution request of processing is received from the Web server 102. If the execution request is received from the Web server 102, the processing proceeds to step S702; otherwise, the processing stands by until a request is received. In step S702, the service provider 450 executes processing in accordance with the content of the execution request received in step S701, and proceeds to step S703. More specifically, the job generation section 452 generates a job for executing the processing requested by the Web server 102, and executes the job. In step S703, the service provider 450 transmits an execution result of the processing to the Web server 102.

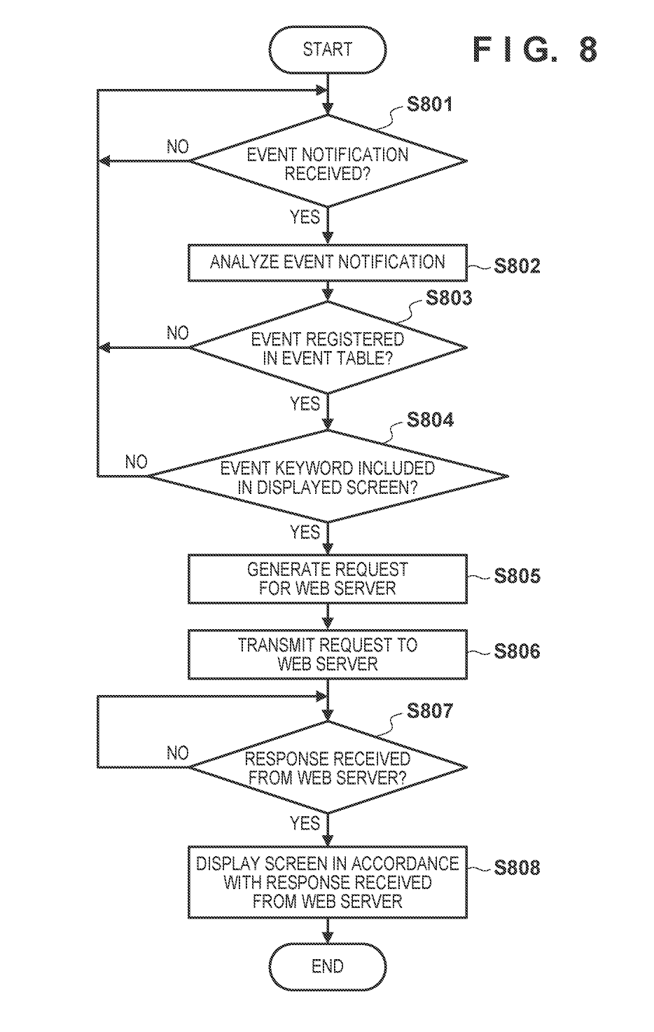

Next, described with reference to FIG. 8 is an operation of the Web browser 440 when an event occurs in the MFP 101.

FIG. 8 is a flowchart for describing event processing executed by the Web browser 440 in the MFP 101. This processing is realized by executing, by the CPU 211 of the MFP 101, a control program developed in the RAM 213.

In step S801, the Web browser 440 determines whether or not an event notification is received from the event processing module 460. If an event notification is received, the processing proceeds to step S802; otherwise, the processing stands by in step S801 until an event notification is received. When an event notification is received, the processing proceeds to step S802, where the Web browser 440 analyzes the received event notification. In step S803, it is determined whether or not the event in the notification, which has been analyzed in step S802, has been registered in the event table 445. If it has been registered, a corresponding keyword is obtained, and the processing proceeds to step S804. In step S804, the Web browser 440 determines whether or not the screen (HTML file) displayed by the Web browser 440 includes the event keyword which has been obtained in step S802. If the keyword is included, the processing proceeds to step S805. Note that, if the event is not registered in the event table 445 in step S803, or if the keyword is not included in the displayed screen in step S804, the processing returns to step S801 and waits for the next event.

In step S805, the Web browser 440 analyzes the screen information displayed by the Web browser 440, and generates a request for the Web server 102. This request corresponds to a request generated in a case where a user selects a button or link corresponding to the keyword acquired in step S802 in the screen displayed by the Web browser 440. For instance, if the keyword is “LOGOUT” and the displayed screen includes a “LOGOUT” link, a request in a case of selecting the “LOGOUT” link on the displayed screen is generated. Further, if the keyword is “LOGOUT” and the displayed screen includes a button captioned as “LOGOUT,” a request in a case of depressing the “LOGOUT” button in the displayed screen is generated.

Next, the processing proceeds to step S806, where the Web browser 440 transmits the request, which has been generated in step S805, to the Web server 102. Then, in step S807, the Web browser 440 determines whether or not screen information of an operation screen is transmitted from the Web server 102 in response to the request transmitted in step S806. When the Web browser 440 receives the screen information of an operation screen, the processing proceeds to step S808; if not, the processing stands by until the screen information is received. In step S808, the Web browser 440 displays an operation screen on the display unit of the console unit 219 in accordance with the description of the received the screen information (HTML file).

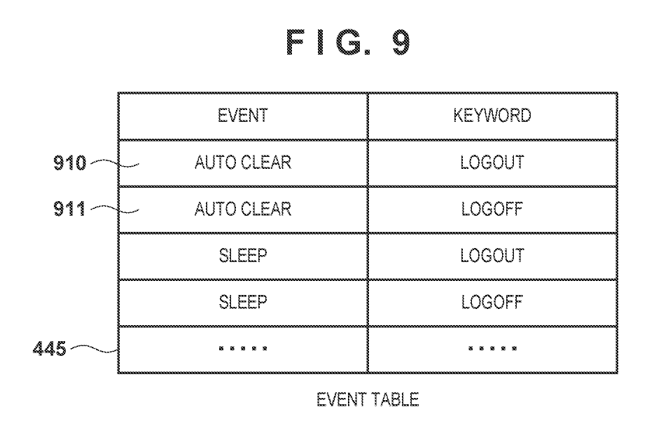

Next, with reference to FIG. 9, the event table 445 is described.

FIG. 9 depicts an explanatory view showing a data structure of the event table 445 included in the MFP 101 according to the present embodiment.

The event table 445 is provided for managing keywords corresponding to events which occur in the MFP 101. Note that the keyword is associated with screen information of a HTML file or the like, which is received by the Web browser 440 from the Web server 102.

For instance, in the field 910, an event “AUTO CLEAR,” which is issued to reset the state of the MFP 101 in a case where the MFP 101 is not operated for a predetermined period of time, is tied to the keyword “LOGOUT.” Similarly, in the field 911, an event “AUTO CLEAR” is tied to the keyword “LOGOFF.” Therefore, if an auto-clear event occurs, keywords “LOGOUT” AND “LOGOFF” corresponding to the event are obtained in step S803 in FIG. 8. Then, in step S804, the Web browser 440 determines whether or not constituent elements of the screen, which is being displayed, include the keyword “LOGOUT” or “LOGOFF.” If it is determined that the keyword exists, the processing proceeds to step S805 for generating a request similar to the case where a user selects a link or button corresponding to the keyword.

Note that, although a keyword is expressed as a fixed text string in FIG. 9, the present invention is not limited to this. A keyword may be expressed by using, for instance, wild cards or regular expressions. Further, the keyword in the field 910 or 911 can be expressed by one keyword “LOGOUT (LOGOFF)” according to regular expressions.

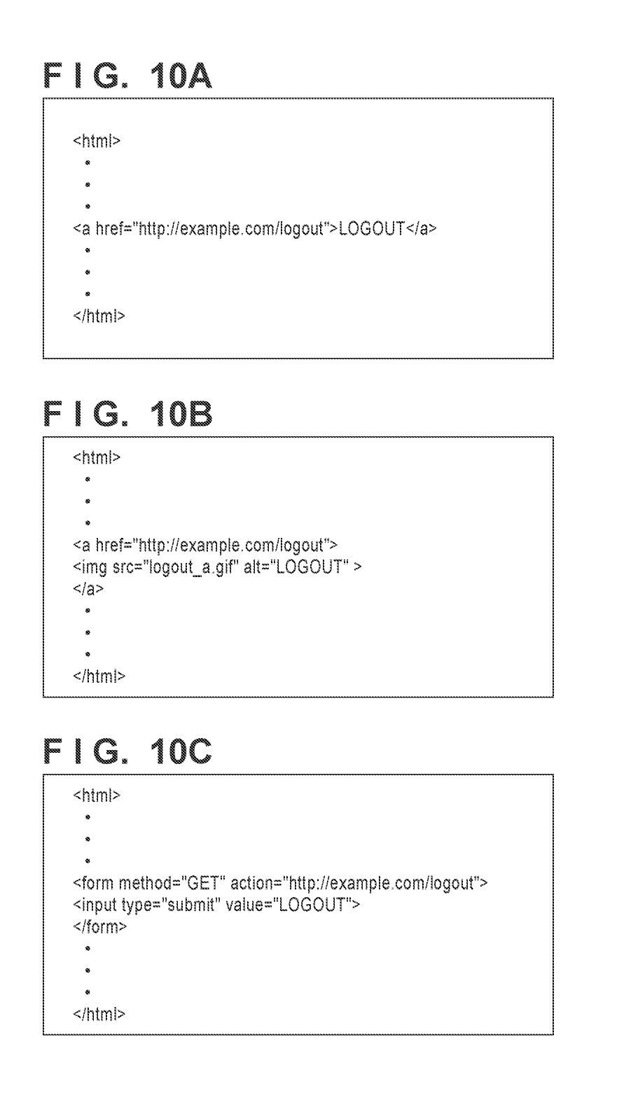

Next, an example of HTML data which matches a keyword is described with reference to FIGS. 10A to 10C.

FIGS. 10A to 10C depict views illustrating examples of specific description of a source (HTML data) of an operation screen displayed by the Web browser 440 according to the present embodiment. Note that, in the example which will be described below, assume that an event “SLEEP,” which is issued to suspend the MFP 101, is tied to the keyword “LOGOUT” as shown in FIG. 9.

Assume that the source of the screen displayed by the Web browser 440 is HTML data shown in FIG. 10A. When a SLEEP event occurs, the Web browser 440 issues a HTTP request to the URL “http://example.com/logout”. This is because the URL includes the same text string as the keyword “LOGOUT.”

Furthermore, assume that the source of the screen displayed by the Web browser 440 is HTML data shown in FIG. 10B. In this case, when a SLEEP event occurs, the Web browser 440 issues a HTTP request to the URL “http://example.com/logout”. This is because the keyword “LOGOUT” matches the “alt” attribute of the “img” tag.

Furthermore, assume that the source of the screen displayed by the Web browser 440 is HTML data shown in FIG. 10C. In this case, when a SLEEP event occurs, the Web browser 440 issues a HTTP request to the URL “http://example.com/logout”. This is because the keyword “LOGOUT” matches the “value” attribute of the “submit” button (input type=“submit”).

As has been described above, according to the present embodiment, the MFP comprises a table in which events are associated with keywords, and in a case where an event occurs in the MFP, a keyword corresponding to the event is obtained. If an item corresponding to the keyword is included in the image information of the screen which is being displayed, a request to the item is automatically transmitted to the Web server.

Accordingly, for instance, by associating an event, which occurs in a case where the MFP is not operated for a predetermined period of time, with “LOGOUT” in the table, the MFP can automatically log out from the Web application when such an event occurs.

Note that, although the above-described embodiment has given an example in which an event, which occurs in a case where no operation is performed for a predetermined period of time, is associated with logout, the present invention is not limited to this. For instance, in a case of an event where no operation is performed for a predetermined period of time, a login screen for user switching or the like, where a new user is authenticated for login, may be displayed.

As has been set forth above, according to the present embodiment, an event which occurs in an information processing apparatus is associated with constituent elements of screen information for displaying an operation screen. When the event occurs, processing similar to the case where a user operates the constituent element on the operation screen can be executed.

### Other Embodiment

Aspects of the present invention can also be realized by a computer of a system or apparatus (or devices such as a CPU or MPU) that reads out and executes a program recorded on a memory device to perform the functions of the above-described embodiment, and by a method, the steps of which are performed by a computer of a system or apparatus by, for example, reading out and executing a program recorded on a memory device to perform the functions of the above-described embodiment. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-226825, filed Oct. 6, 2010, which is hereby incorporated by reference herein in its entirety.

What is claimed is:

1. An information processing apparatus having a Web browser, which is capable of communicating with a Web server, and displays an operation screen based on screen information supplied by the Web server, comprising:
a transmission unit configured to transmit a request to the Web server based on a user operation through the operation screen displayed by the Web browser; and
a control unit configured to, in a case where an event occurs in the information processing apparatus, specify a constituent element of the operation screen, which is corresponding to the occurred event, and transmit a request, to the Web server, which is similar to a case where a user selects the constituent element.

2. The information processing apparatus according to claim 1, further comprising:
a storage unit configured to store a keyword corresponding to an event which occurs in the information processing apparatus,
wherein the control unit acquires a corresponding keyword from the storage unit based on an event occurred in the information processing apparatus, and specifies a constituent element including the keyword among the constituent elements of screen information displayed by the Web browser.

3. The information processing apparatus according to claim 2, wherein the storage unit stores information which associates an event that occurs when the information processing apparatus is not operated for a predetermined period of time, with a keyword of a constituent element for logging out from the Web server.

4. A control method of controlling an information processing apparatus having a Web browser, which is capable of communicating with a Web server, and displays an operation screen based on screen information supplied by the Web server, the method comprising:
transmitting a request to the Web server based on a user operation through the operation screen displayed by the Web browser; and
controlling, in a case where an event occurs in the information processing apparatus, to specify a constituent element of the operation screen, which is corresponding to the occurred event, and transmit a request, to the Web server, which is similar to a case where a user selects the constituent element.

5. A non-transitory computer-readable storage medium, which stores a program for causing a computer to execute a control method of an information processing apparatus having a Web browser, which is capable of communicating with a Web server, and displays an operation screen based on screen information supplied by the Web server, said method comprising:
transmitting a request to the Web server based on a user operation through the operation screen displayed by the Web browser; and
controlling, in a case where an event occurs in the information processing apparatus, to specify a constituent element of the operation screen, which is corresponding to the occurred event, and transmit a request, to the Web server, which is similar to a case where a user selects the constituent element.
